(19) United States
(12) Patent Application Publication
(10) Pub. No.: US 2014/0375183 A1
(43) Pub. Date: Dec. 25, 2014

(54) ELECTRONIC DEVICE ENCLOSURE FOR STORAGE DEVICES

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: LIANG-CHIN WANG, New Taipei (TW); YU-MING XIAO, Wuhan (CN); ZAN LI, Wuhan (CN); LING-XIN ZENG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/219,017

(22) Filed: Mar. 19, 2014

(30) Foreign Application Priority Data
Jun. 20, 2013 (CN) 2013102459544

(51) Int. Cl. G06F 1/18

(52) U.S. Cl. CPC G06F 1/187
USPC 312/223.1

(57) ABSTRACT

An electronic device enclosure includes a case; a securing member attached to the case, and a bracket used for receiving a storage device. The securing member defines a receiving hole, and a limiting portion is located on the securing member. The limiting portion comprises a plurality of protruding blocks. The bracket comprises a resisting portion and a rotating portion movably received in the receiving hole. The bracket is rotatable about the rotating portion relative to the case. The resisting portion is resisted on one of the plurality of protruding blocks to prevent the bracket from moving.

### BACKGROUND

1. Technical Field

The present disclosure relates to electronic device enclosures, and particularly to an electronic device enclosure for securing storage devices in an electronic device.

2. Description of Related Art

Many personal computers include data storage devices such as hard disk drives (HDDs), floppy disk drives, and compact disc-read only memory (CD-ROM) drives. Data storage devices are received in a bracket that is attached to a computer enclosure. A very small distance is defined between the bracket and a panel of the computer enclosure, and it is inconvenient for a thumb to enter into the small distance to catch the storage device for maintenance.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device enclosure in accordance with an embodiment.

FIG. 2 is similar to FIG. 1, but viewed from a different aspect.

FIG. 3 is an isometric view of a securing member of the electronic device enclosure of FIG. 1.

FIG. 4 is an assembled view of the electronic device enclosure of FIG. 1, but a cover of the electronic device enclosure of the FIG. 1 is not shown.

FIG. 5 is a side view of the electronic device enclosure of FIG. 1.

FIG. 6 is an assembled view of the electronic device enclosure of FIG. 1.

FIG. 7 is a cross-sectional view of FIG. 4, taken along a line VII-VII, and a sliding portion is located on a bottom portion of a sliding groove.

FIG. 8 is similar to FIG. 7, and the sliding portion is located on a middle portion of the sliding groove.

FIG. 9 is similar to FIG. 7, and the sliding portion is located on an entrance of the sliding groove.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

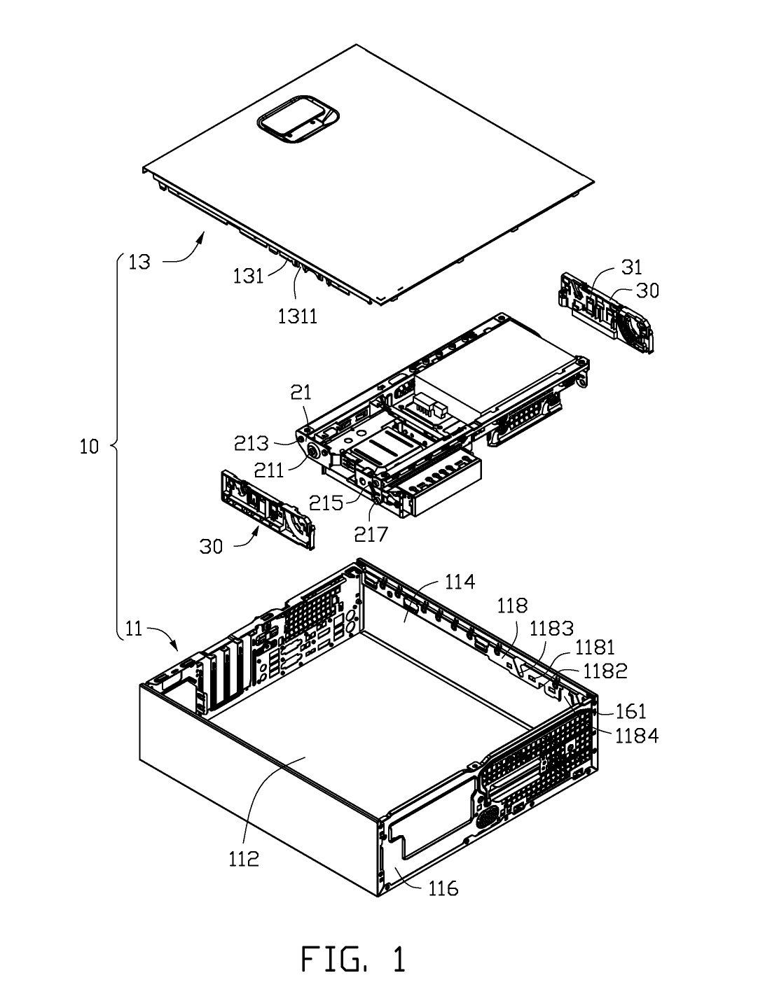

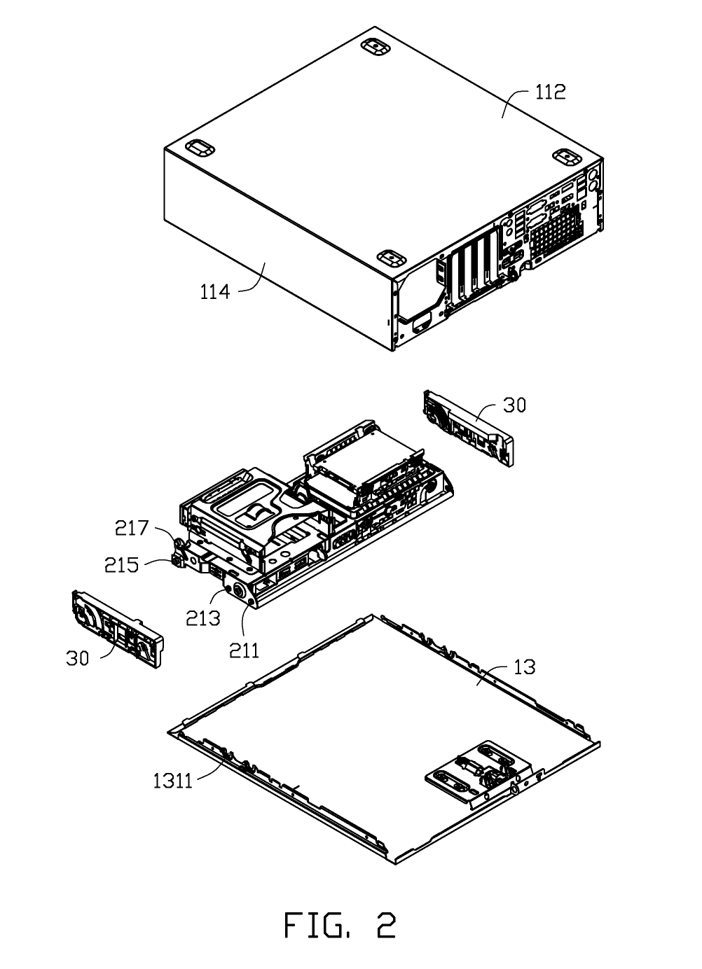

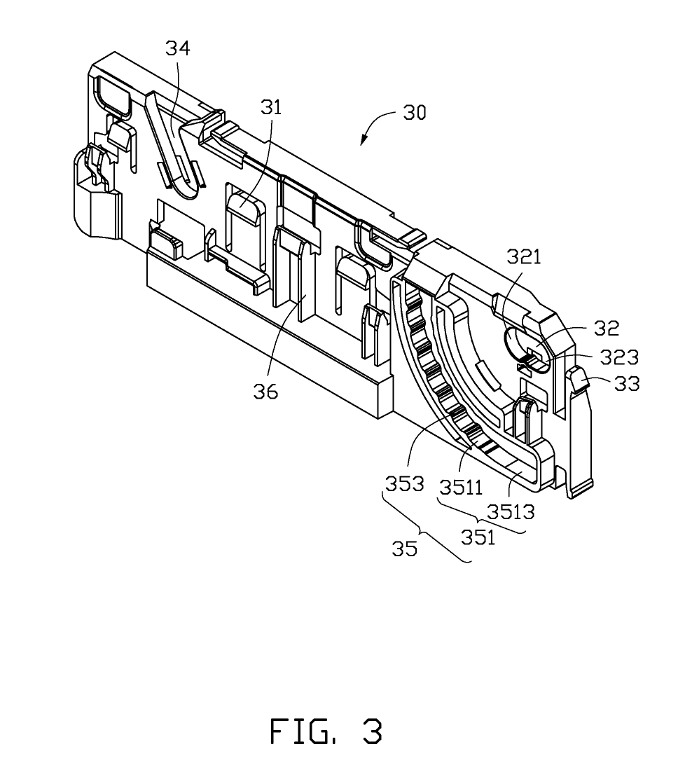

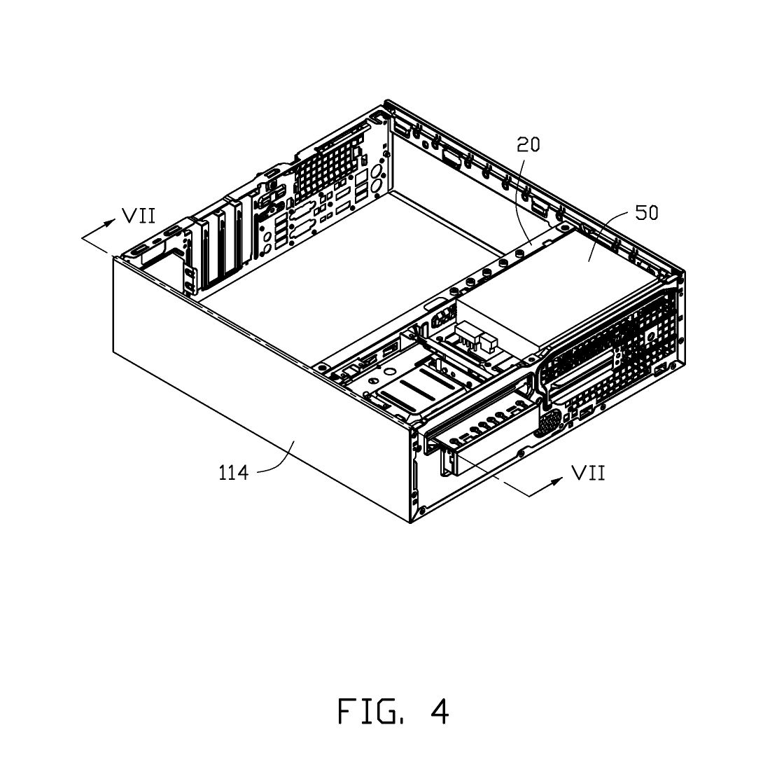

FIGS. 1-3 illustrate an electronic device enclosure in accordance with an embodiment. The electronic device enclosure comprises a case 10, a bracket 20 attached to the case 10, and two securing members 30 attached to opposite sides of the bracket 20. The bracket 20 is used to receive a data storage device 50 (see FIG. 4). The storage device maybe a hard disk drive (HDD), a floppy disk drive, and an optical disk drive.

The case 10 comprises a main body 11 and a cover 13. The main body 11 comprises a bottom plate 112, two side plates 114, and a front plate 116. In one embodiment, the two side plates 114 are substantially parallel to each other and perpendicular to the bottom plate 112 and the front plate 116. A mounting panel 118 is connected to each side plate 114 and defines a plurality of first clipping holes 1181, a positioning slot 1182, a sliding slot 1183, and a cutout 1184. In one embodiment, the mounting panel 118 is substantially parallel to the side plate 114, and the sliding slot 1183 is slanted relative to a top edge of the side plate 114. The front plate defines a second clipping hole 161. The cover 13 comprises two opposite flanges 131. Each flange 131 defines a two receiving slots 1311.

The bracket 20 comprises two side panels 21. Each side panel 21 comprises a sliding portion 211 and two positioning portions 213 located at opposite sides of the sliding portion 211. Each positioning portion 213 corresponds to the receiving slot 1311. Each side panel 21 further comprises a rotating portion 215 and a resisting portion 217 below the rotating portion 215.

Each securing member 30 defines a plurality of first clipping blocks 31, a second clipping block 33, and a plurality of limiting ribs 36. The plurality of first clipping blocks 31 correspond to the plurality of first clipping holes 1181, the second clipping block 33 corresponds to the second clipping hole 1161, and the plurality of limiting ribs 36 corresponds to the plurality of positioning slots 1182. Each securing member 30 further defines a receiving hole 32 and a sliding groove 34. In one embodiment, the receiving hole 32 comprises a first end 321 and a second end 323 opposite to the first end 321. In one embodiment, the sliding groove 34 is same as the sliding slot 1183 and is slanted relative to a top edge of the securing member 30. A limiting portion 35 is located on the securing member 20 and adjacent to the receiving hole 32. The limiting portion 35 comprises a sliding surface 351 and a plurality of protruding blocks 353 located on the sliding surface 351. The sliding surface 351 comprises an arcuate portion 3511 and a horizontal portion 3513 connected to the arcuate portion 3511. In one embodiment, the plurality of protruding blocks 353 is located on the arcuate portion 3511.

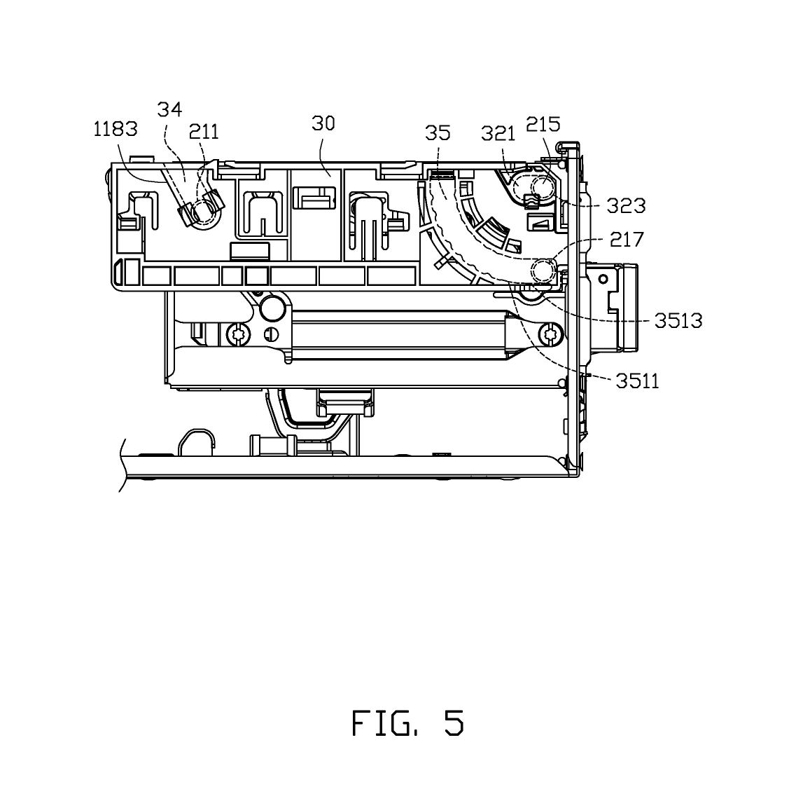

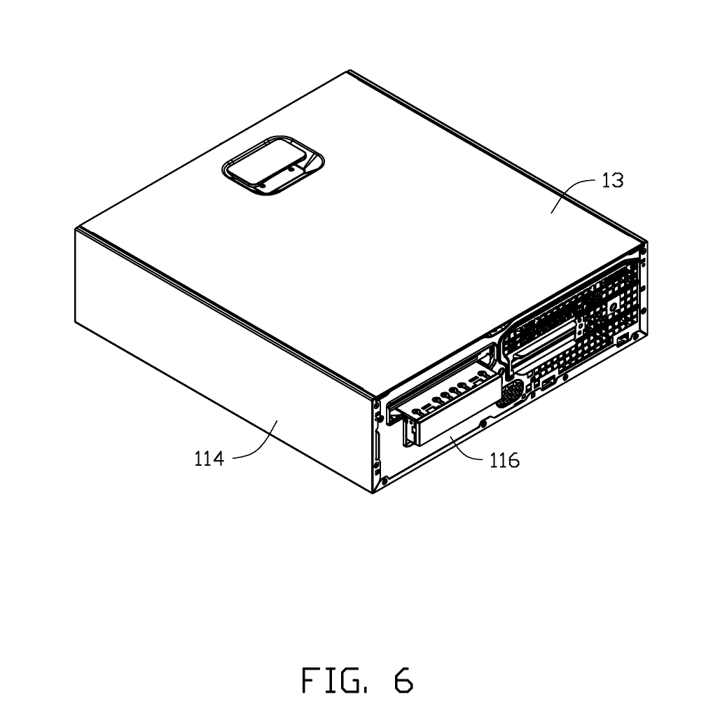

FIGS. 4-7 illustrate assembly of the electronic device enclosure of an embodiment. Each mounting member 30 is inserted into a gap defined between each side plate 114 and the mounting panel 118. The plurality of first clipping portions 31 is clipped in the plurality of first clipping holes 1181, and the second clipping portion 33 is clipped in the second clipping hole 1161 to secure the mounting member 30 to the side plate 114. The limiting rib 36 is engaged in the positioning slot 1182 to prevent the mounting member 30 from moving. The sliding groove 34 is aligned with the sliding slot 1183, and the receiving hole 32 and the limiting portion 35 are exposed from the mounting panel 118 via the cutout 1184.

The bracket 20 is located between the two securing members 30. The bracket 20 urges the two securing members 30 to slide the rotating portion 215 into the second end 323 of the receiving hole 32. The bracket 20 is rotated about an axis (rotating portion 215) towards the bottom plate 112, until the sliding portion 211 extends through the sliding slot 1183 and located at an entrance of the sliding groove 34. The resisting portion 217 is resisted on a first end of the limiting portion 35, the rotating portion 215 is slid to the second end 323 from the first end 321. The bracket 20 is further rotated, the sliding portion 211 is received in a bottom portion of the sliding groove 34, and the resisting portion 217 is resisted on a second end of the limiting portion 35. Thus, the bracket 20 is secured to the main body 11.

The cover 13 covers the main body 11, the positioning portions 213 are received in the corresponding receiving slots 1311 to prevent the bracket 20 from moving upward.

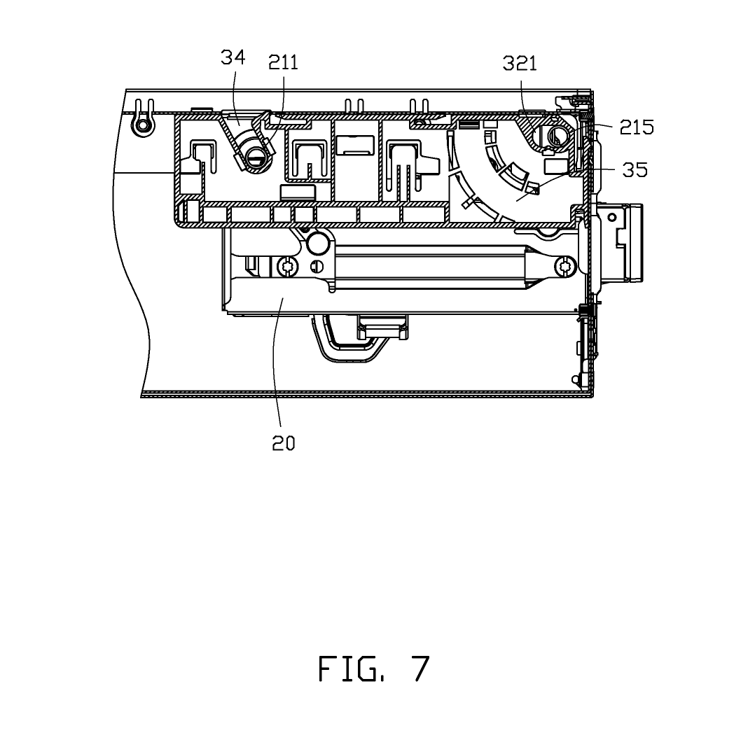

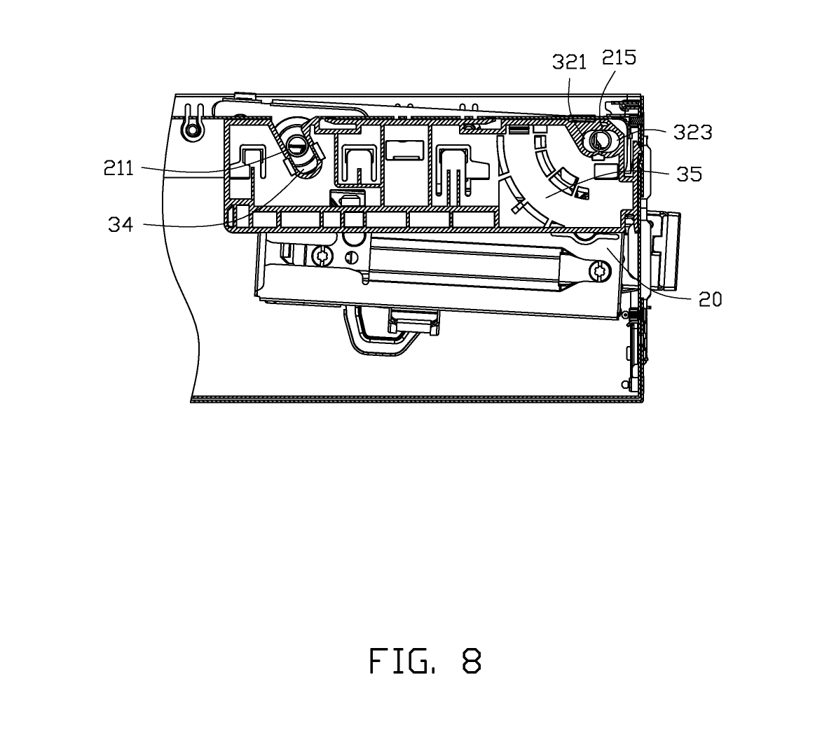

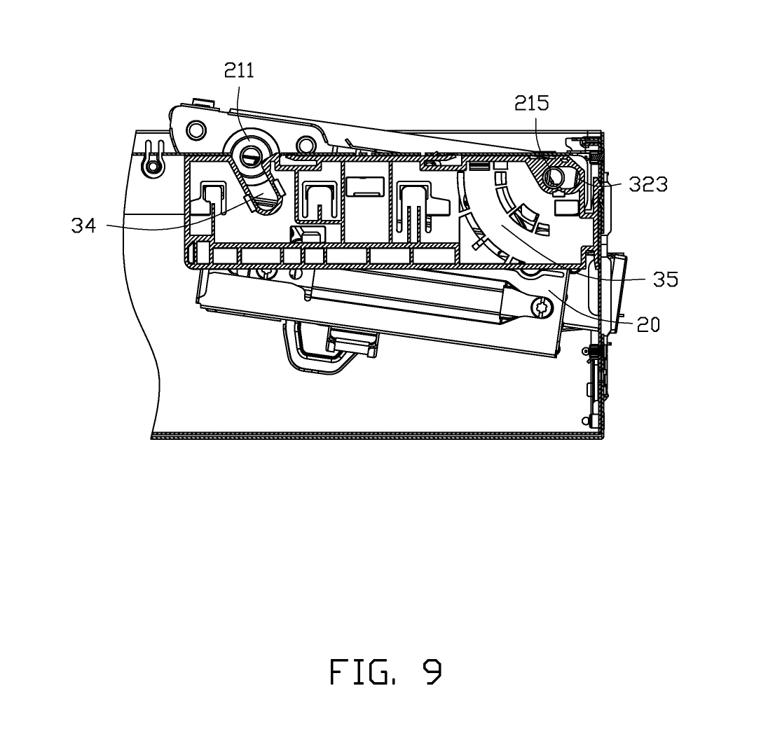

FIGS. 7-9 illustrate disassembly of the electronic device enclosure of an embodiment. The cover 13 is moved to disengage the positioning portions 213 from the receiving slots 1311. The bracket 20 is rotated to slide the sliding portion 211 in the sliding groove 34. The rotating portion 215 is slid to the first end 321 from the second end 323, and the resisting portion 217 is slid from the horizontal surface 3513 to the arcuate surface 3511. When the rotating portion 215 is located on the first end 321, the bracket 20 is further rotated, and the sliding portion 211 can be disengaged from the sliding groove 34. A friction force is defined between the resisting portion 217 and the limiting portion 35 to position the resisting portion 217 on anyone of the plurality of protruding blocks 35 (see FIG. 9), and the storage device 50 can be maintained easily.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device enclosure comprising:
a case;
a securing member attached to the case; the securing member defining a receiving hole, and a limiting portion located on the securing member; the limiting portion comprising a plurality of protruding blocks; and
a bracket configured for receiving a storage device; the bracket comprising a resisting portion and a rotating portion movable received in the receiving hole,
wherein the bracket is rotatable about the rotating portion relative to the case, and the resisting portion is resisted on one of the plurality of protruding blocks to prevent the bracket from moving relative to the case.

2. The electronic device enclosure of claim 1, wherein the limiting portion comprises a sliding surface, the sliding surface comprises an arcuate surface and a horizontal surface connected to the arcuate surface, and the plurality of protruding blocks is located on the arcuate surface.

3. The electronic device enclosure of claim 1, wherein the securing member defines a sliding groove, and the bracket further comprises a sliding portion slidably received in the sliding groove.

4. The electronic device enclosure of claim 3, wherein the sliding groove is slanted relative to a top edge of the securing member.

5. The electronic device enclosure of claim 4, wherein the case comprises a side plate and a mounting panel connected to the side plate, the securing member is located between the mounting panel, and the side plate and is secured to the mounting panel.

6. The electronic device enclosure of claim 5, wherein the mounting panel defines a sliding slot aligned with the sliding groove, and the sliding portion extends through the sliding slot to receive in the sliding groove.

7. The electronic device enclosure of claim 5, wherein the mounting panel is substantially parallel to the side plate.

8. The electronic device enclosure of claim 5, wherein the case further a front plate substantially perpendicular to the side plate, the mounting panel defines a first clipping hole, the front plate defines a second clipping hole, and the securing member further comprises a first clipping portion located in the first clipping hole and a second clipping portion located in the second clipping hole.

9. The electronic device enclosure of claim 1, wherein the case comprises a cover and a flange connected to the cover, the flange defines a receiving slot, and the bracket comprises a positioning portion engaged in the receiving slot.

10. An electronic device enclosure comprising:
a case comprises a side plate and a mounting panel connected to the side plate; the mounting panel defining a first clipping hole, a securing member located between the side plate and mounting panel; the securing member comprises a first clipping portion clipped in the first clipping hole, a receiving hole is defined in the securing member, and a limiting portion located on the securing member and exposed out of the mounting panel; the limiting portion comprising a plurality of protruding blocks; and
a bracket configured for receiving a storage device; the bracket comprising a resisting portion and a rotating portion movable received in the receiving hole; and
wherein the bracket is rotatable about the rotating portion relative to the case, and the resisting portion is resisted on one of the plurality of protruding blocks to prevent the bracket from moving.

11. The electronic device enclosure of claim 10, wherein the mounting panel is substantially parallel to the side plate.

12. The electronic device enclosure of claim 10, wherein the limiting portion comprises a sliding surface, the sliding surface comprises an arcuate surface and a horizontal surface connected to the arcuate surface, and the plurality of protruding blocks is located on the arcuate surface.

13. The electronic device enclosure of claim 10, wherein the securing member defines a sliding groove, and the bracket further comprises a sliding portion slidably received in the sliding groove.

14. The electronic device enclosure of claim 13, wherein the sliding groove is slanted relative to a top edge of the securing member.

15. The electronic device enclosure of claim 13, wherein the mounting panel defines a sliding slot aligned with the sliding groove, and the sliding portion extends through the sliding slot to receive in the sliding groove.

16. The electronic device enclosure of claim 10, wherein the case further a front plate substantially perpendicular to the side plate, the front plate defines a second clipping hole, and the securing member further comprises a second clipping portion clipped in the second clipping hole.

17. The electronic device enclosure of claim 10, wherein the case comprises a cover and a flange connected to the cover, the flange defines a receiving slot, and the bracket comprises a positioning portion engaged in the receiving slot.
